(19) United States
(12) Patent Application Publication
(10) Pub. No.: US 2012/0264101 A1
(43) Pub. Date: Oct. 18, 2012

(54) SYSTEM AND METHOD FOR ASSESSMENT TESTING AND CREDENTIAL PUBLICATION

(75) Inventors: ERIC KROHNER, FARMINGTON HILLS, MI (US); CHRIS CUNNINGHAM, HIXSON, TN (US); RICHARD STUHLSATZ, WASHINGTON, MI (US); MATTHEW LEESE, WESTLAND, MI (US)

(73) Assignee: LOGI-SERVE LLC, Bloomfield Hills, MI (US)

(21) Appl. No.: 13/528,003

(22) Filed: Jun. 20, 2012

Related U.S. Application Data
(63) Continuation-in-part of application No. 13/209,492, filed on Aug. 15, 2011.
(60) Provisional application No. 61/453,353, filed on Mar. 16, 2011.

(51) Int. Cl. G09B 7/00

(52) U.S. Cl. 434/359

(57) ABSTRACT

A computer-implemented method for publishing a user credential includes receiving a score regarding at least one capability of an individual, wherein the score is based at least on a plurality of test inputs provided by the individual in response to an assessment test; receiving permission, from the individual, to allow publication of a credential certificate on a computer-implemented user profile associated with the individual, wherein the credential certificate is based at least in part on the score and includes at least one interface element for requesting additional information related to the individual; publishing the credential certificate and at least one interface element on the computer-implemented user profile associated with the individual; and providing a link to the additional information in response to a request for the additional information from the authorized employer, wherein the request is based on activation of at least one interface element by the authorized employer.

### CROSS-REFERENCE TO RELATED APPLICATIONS

This application is a continuation-in-part of U.S. application Ser. No. 13/209,492, filed on Aug. 15, 2011, which claims priority to Provisional Application No. 61/453,353 filed on Mar. 16, 2011, which are incorporated by reference.

### TECHNICAL FIELD

The disclosure relates to the field of assessment testing, and more particularly, to systems and methods for assessment testing and credential publication.

### BACKGROUND

Across many industries, businesses and other organizations strive to meet the requirements of a competitive marketplace and other challenges. For example, many business strive to provide excellent service to customers and clients. Whatever a business or other organization's objectives, it is often useful to recruit, hire and appropriately train employees, contractors, students, volunteers or others who are capable of meeting these objectives through the performance of their responsibilities. Training programs and talented managers are components of these efforts. Research and experience have shown, however, that some persons are better suited for employment in service positions than others.

For example, during a typical hiring process, a job candidate is interviewed to determine whether the candidate would be able to competently perform the duties associated with the position. In service oriented fields, traditional interviewing techniques tend to be poor indicators of a candidate's ability to provide excellent service to customers or clients.

As an example, a candidate's responses to questions posed by a prospective employer might better reflect the candidate's perception as to what the “correct” answers are, rather than being sincere and genuine answers. Such answers provide little insight to the actual opinions and attitudes of the candidate toward providing service and provide no insight as to the emotional and behavioral capacity of the Applicant to provide excellent service to customers or clients. Assessment testing has long been used as a tool for screening potential job candidates. Often, however, these tests are overly complex, lengthy, and fail to fully engage the candidate, which leads to test-taking fatigue, disinterest, and drop-off.

Assessment testing can also be limited in application, for example, to potential job candidates who express interest in a position during a specific hiring process. The recruiter or employer is thus limited to providing assessment testing and evaluating the credentials and competencies of job candidates who directly express interest in a given position.

### SUMMARY

Disclosed herein are embodiments of systems and methods for assessment testing and credential publication.

One aspect of the disclosed embodiments is a computer-implemented method for publishing a user credential. The method includes receiving a score regarding at least one capability of an individual. The score is based at least on a plurality of test inputs provided by the individual in response to an assessment test. The method further includes receiving permission, from the individual, to allow publication of a credential certificate on a computer-implemented user profile associated with the individual. The credential certificate is based at least in part on the score and includes at least one interface element for requesting additional information related to the individual. The method further includes publishing the credential certificate and at least one interface element on the computer-implemented user profile associated with the individual and providing, to an authorized employer, a link to the additional information in response to a request for the additional information from the authorized employer. The request is based on activation of at least one interface element by the authorized employer.

Another aspect of the disclosed embodiments is a non-transitory computer readable medium including program instructions executable by one or more processors that, when executed, cause the one or more processors to perform operations. The operations comprise receiving a score regarding at least one capability of an individual. The score is based at least on a plurality of test inputs provided by the individual in response to an assessment test. The operations further comprise receiving permission, from the individual, to allow publication of a credential certificate on a computer-implemented user profile associated with the individual. The credential certificate is based at least in part on the score and includes at least one interface element for requesting additional information related to the individual. The operations further comprise publishing the credential certificate and at least one interface element on the computer-implemented user profile associated with the individual and providing, to an authorized employer, a link to the additional information in response to a request for the additional information from the authorized employer. The request is based on activation of at least one interface element by the authorized employer.

### BRIEF DESCRIPTION OF THE DRAWINGS

The description herein makes reference to the accompanying drawings wherein like reference numerals refer to like parts throughout the several views, and wherein:

FIG. 1 is a diagram showing an assessment testing system implemented in an exemplary environment;

FIG. 2 is an illustration showing an ideal service provider evaluation screen of the assessment system;

FIG. 3 is an illustration showing a first service scenario screen;

FIG. 4 shows a second service scenario screen;

FIG. 5 is an illustration showing a self evaluation screen;

FIG. 6 is an illustration showing a grouping of slider bar controls;

FIG. 7A is a graphical representation of a service scenario illustrating relative placement of a customer and a service provider;

FIG. 7B is an illustration showing a graphical service scenario, wherein company-specific branding is applied;

FIG. 8A shows a background element of the graphical service scenario;

FIG. 8B shows a service provider element of the graphic service scenario;

FIG. 8C shows a customer element of the graphical service scenario;

FIG. 8D shows a composite of the background, the service provider element, and the customer element to produce the final graphical service scenario;

FIG. 9 is a flow chart showing a method for evaluating at least one capability of an individual seeking or holding a job with a specified employer;

FIG. 10 is a flow chart showing a computer-implemented method for testing at least one capability of an individual;

FIG. 11 is a flow chart showing a computer-implemented method for evaluating at least one capability of an individual seeking or holding employment;

FIG. 12 is a flow chart showing a method for evaluating at least one capability of an individual seeking or holding a job with a specified employer;

FIG. 13 is a flow chart showing a method for evaluating at least one capability of an individual seeking or holding a job with a specified employer;

FIG. 14 is a flow chart showing a method for evaluating at least one capability of an individual seeking or holding a job with a specified employer;

FIG. 15 is an illustration showing a credential certificate on a computer-implemented profile of an individual;

FIG. 16 is an illustration showing a competencies-and-endorsements certificate;

FIG. 17 is a flow chart showing a method for publishing a user credential; and

FIG. 18 is a block diagram showing an exemplary computer system.

### DETAILED DESCRIPTION

In the methods of assessment testing and credential publication described here, authorized employers can review the various capabilities of individuals seeking or holding jobs through the use of credential certificates published on computer-generated user profiles. A credential certificate can include one or more assessments of the individual's capabilities based on the individual's responses to an assessment test. Additional details related to the results of the assessment test can be delivered to authorized employers through the use of interface elements. When assessment testing and credential publication are used in conjunction with user-generated profiles, authorized employers can expand the pool of potential job candidates beyond individuals expressing interest in a specific job opening. Potential job candidates can also expand their visibility to and credibility with potential employers using credential certificates.

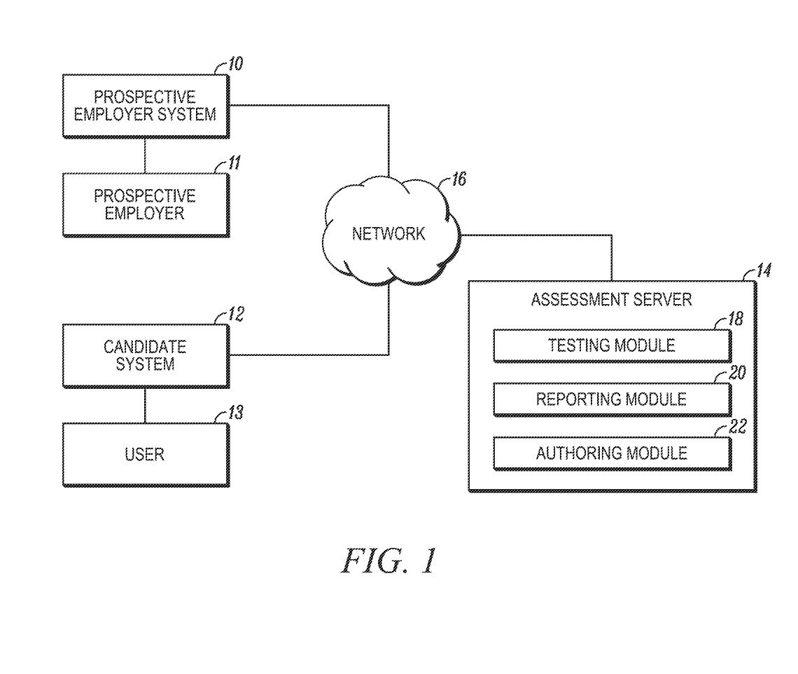

FIG. 1 is a diagram showing a system and method for assessment testing implemented in an exemplary environment. A prospective employer system 10, a candidate system 12, and an assessment server 14 are connected to one another by a network 16. Each of these systems may be a single system or multiple systems. The network 16 allows communication between them in any suitable manner. In one exemplary embodiment, the prospective employer is a service provider engaged in a customer service business such as a retail store, hotel or almost any other type other business that seeks to hire and train its employees to provide to good customer service. The system and method taught herein is also useful for any type of organization that seeks to recruit, hire, train, manage and/or deploy people to perform a function (such as leadership, management, service or safety) at a certain level of competency. It is not limited to for-profit businesses. For example, government agencies such as police and fire departments as well as not-for-profit groups such as schools and charities can use the systems and methods taught herein with respect to their employees, students, and/or volunteers. The term “employer” thus refers to any such business, government agency, sports team or other organization that recruits, trains, manages and/or deploys people Likewise, the term “employee” refers to any employee, contractor, student, volunteer, or other person who is being recruited, trained, managed or deployed by an employer. The term “job” means any set of responsibilities, paid or unpaid, whether or not part of an employment relationship, that need to be performed competently.

In one exemplary embodiment, the assessment testing described herein is directed to the prospective employee's ability to provide good customer service. Any other aptitudes and abilities can be tested as well, such as a prospective employee's ability to perform a job safely or ability to be an effective leader or to work with attention to detail Likewise, both prospective and current employees can be tested. For example, current employees can be tested to for purposes of determining new assignments for the current employees.

The assessment server 14 is provided with assessment software including a testing module 18, a reporting module 20, and an authoring module 22. The testing module 18, the reporting module 20, and the authoring module 22 each include computer executable instructions that, when executed, perform functions that will be explained herein. In the context of the testing module 18, the reporting module 20, and the authoring module 22, the term “module” refers to a set grouping of related functions. Each “module” can be implemented as a single software program, a set of related software programs, or as part of a software program including additional related or unrelated functionality. All of the “modules” described herein can be implemented in a single software program.

The testing module 18 is invoked when the assessment server 14 is accessed by the candidate system 12. The testing module 18 is operable to generate an assessment test, which is delivered to the candidate system 12 by the assessment server 14. The candidate system 12 receives the assessment test from the assessment server 14 and displays the assessment test using appropriate software, such as a web browser, a specialized software client, or other suitable software. During administration of the assessment test by the candidate system 12, the candidate system 12 receives input from a user 13 and transmits the user input to the assessment server 14. As one example, the user 13 can be seeking or holding employment with a specified employer, such as a prospective employer 11. In other examples, the user 13 can be in a role other than that of seeking or holding employment with a specified employer 11, such as a person wishing to volunteer for a non-profit. Thus, while terms such as “candidate,” “employee,” and “employer” are used for purposes of explanation, these terms are not meant to imply that use of the system is limited to this specific context.

The assessment test can be delivered to the candidate system 12 by the assessment server 14 in the form of a web application that includes one or more web pages. These web pages are displayed by candidate system 12, and request input from the user 13 of the candidate system 12. The assessment test can also be delivered to the candidate system 12 by a user-profile server. In the user-profile server example, the user 13 has a computer-implemented user profile stored on the user-profile server, and the computer-implemented user profile includes information related to the user 13. The user 13 can be an individual who enters the information into the computer-implemented user profile for publication to other parties.

During administration of the assessment test, the testing module 18 presents a series of stimuli to the user 13 of the candidate system 12 and receives from the candidate system 12 an input in response to each stimulus. These stimuli can be presented as web page screens that are displayed to the user by the candidate system 12. The various web page screens are operable to receive user input in response to the stimuli, and to cause the candidate system 12 to transmit the input to the assessment server 14. The input is utilized to rate the ability of the user 13 to provide service to customers of the prospective employer 11, as will be explained in detail herein.

On first accessing the testing module 18, a biographical information input screen is transmitted to the candidate system 12 by the assessment server 14. The biographical information input screen asks the user 13 of the candidate system 12 to provide biographical information to the testing module 18. This biographical information can include information that is sufficient to allow the prospective employer 11 to identify and contact the user 13 after the assessment test is completed. The biographical information input screen is operable to receive the biographical information and to cause the candidate system 12 to transmit the biographical information to the assessment server 14. The biographical information can be stored by the assessment server 14 in a secure format in order to protect the privacy of the user of the candidate system 12. Alternatively, the biographical information can be extracted from the user's computer-implemented user profile stored on the user-profile server.

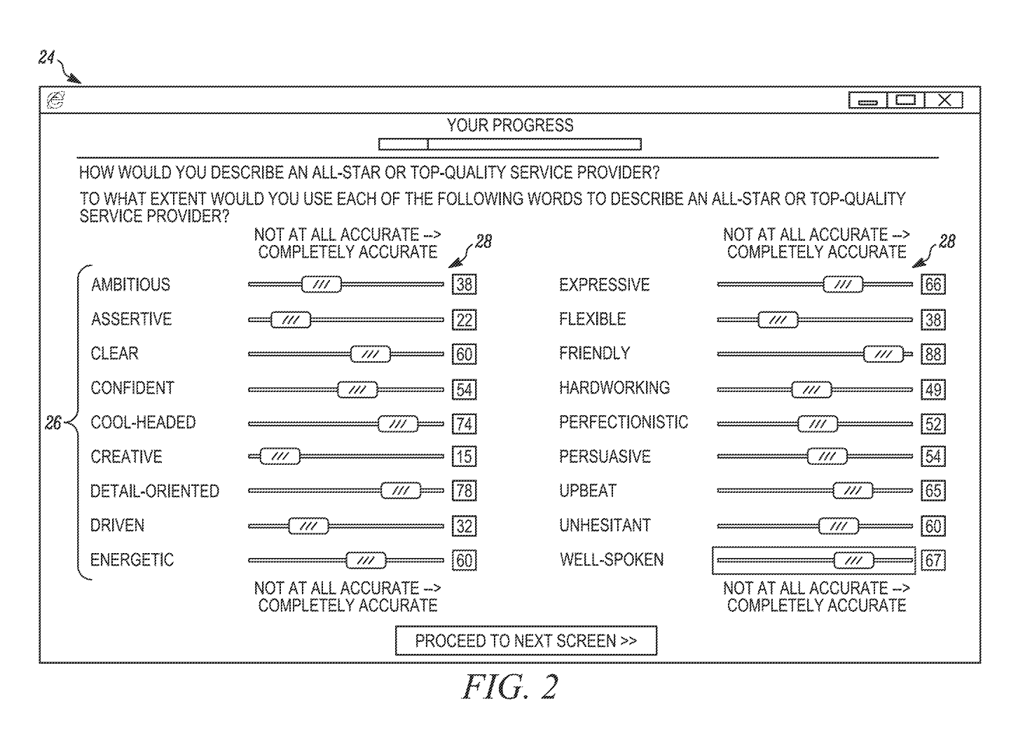

The assessment test can include assessment of the past experiences of the user 13 of the candidate system 12. In order to receive input describing the past experiences of the user 13 of the candidate system 12, the assessment test includes a past experiences input screen, as shown in FIG. 2. The past experiences input screen is generated by the testing module 18 and is transmitted to the candidate system 12 by the assessment server 14.

The past experiences input screen includes one or more past experiences questions, each identifying an activity. For each of the past experiences questions, the past experiences input screen accepts a past experiences input from the user 13 of the candidate system 12 regarding the activity. The activities included on the past experiences input screen are customer service or client service activities, activities that in some way relate to customer service or client service, or activities that serve as predictors of aptitude for customer service or client service. The activities can pertain to a previous work environment or can pertain to experience servicing others outside of a work environment. By providing the past experiences inputs, the user 13 of the candidate system 12 is rating his or her own level of past service experience.

Various formats can be utilized for the past experience inputs. Each past experience input can be a selection from a set of predefined answers. Alternatively, each past experiences input can be a numeric input. Each past experience input can be a separate input control, such as a text field, a list box, a combo box, or a radio button. As another example, each past experience input can be a slider control that allows the user 13 of the candidate system 12 to slide an indicator continuously along a value range having a minimum value and a maximum value, as will be explained in detail herein.

The assessment test includes assessment of the attitudes of the user 13 of the candidate system 12 regarding the qualities that an ideal service provider possesses. As shown in FIG. 2, an ideal service provider evaluation screen 24 is presented to the user of the candidate system 12. The ideal service provider evaluation screen 24 tasks the user 13 of the candidate system 12 with rating a variety of personality qualities 26 in terms of their accuracy as descriptors of an extrinsic ideal service provider. These attributes are personality attributes that have been previously associated with a capability, e.g. competency, that is relevant to the performance of the job for which the user of the candidate system 12 is applying. The attributes, however, can be non-industry specific, such that the assessment test can be applied in different contexts without modifying the attributes. The attributes can be a subset of attributes that are selected by analyzing a plurality of attributes with respect to their correlation to the capability, where the subset is selected based on a high correlation between the attribute and the capability. The resulting subset of attributes can be used as the basis of an assessment that is universally competent, i.e. the assessment can be deployed across multiple positions and industries without modification.

An input control 28 is associated with each of the personality qualities 26. Each input control 28 accepts an input from the user of the candidate system 12 that represents an assessment by the user as to the relative importance of that attribute to the performance of the job. The user's responses are indicated using the input controls 28, are transmitted to the assessment server 14, and are stored and processed by the testing module 18.

The assessment test also includes an assessment of the ability of the user 13 of the candidate system 12 to make appropriate judgments in service situations, and to understand the likely effect of his or her actions in those situations. These scenarios can relate to the performance of a customer service or client service related task or performance of an internal service related task. Examples of internal service related tasks include interactions with coworkers, supervisors, and/or managers.

The user 13 is guided through a series of service judgment scenarios. Each service judgment scenario includes a plurality of service scenario screens. Each service scenario screen is generated by the testing module 18, transmitted to the candidate system 12 by the assessment server 14, and displayed to the user 13 by the candidate system 12.

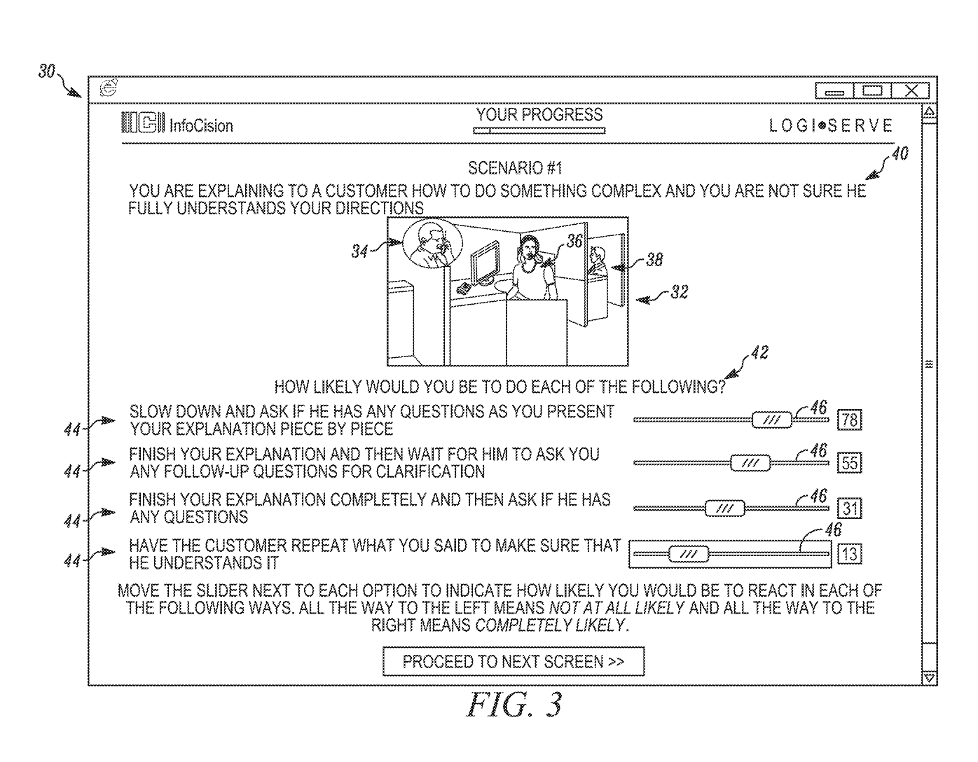

A first service scenario screen 30 is presented to the candidate system 12 by the assessment server 14, as shown in FIG. 3. The first service scenario screen 30 includes a graphical representation 32 of a service judgment scenario. The graphical representation 32 includes depictions of a customer 34 and a service provider 36 in an environment 38, as will be explained further herein. The terms “customer” and “service provider” are used broadly herein. The term “customer” refers to any person being served, aided, assisted, etc., regardless of whether revenue is generated by the transaction, and includes both internal customers and external customers or clients. The term “service provider” refers to any person who is serving, aiding, assisting, etc. As an example, the service provider 36 could be a sales associate and the customer 34 could be an external customer who is attempting to purchase goods or services. As another example, the service provider 36 could be a manager and the customer 34 could be an employee who is being managed by the service provider 36. In this example, the assessment testing could be directed toward assessing leadership ability.

As yet another example, the service provider 36 could be a policeman and the “customer” 34 could be a criminal being arrested. In that case, the assessment testing could be directed toward asserting authority, adhering to police department policies, or remaining calm in dangerous situations. Along with the graphical representation 32, the candidate system 12 is presented with a scenario description 40. The scenario description 40 is provided with the graphical representation 32, in order to explain the situation that is occurring in the scene depicted by the graphical representation 32. The scenario description 40 can be a textual description of a situation that is occurring during an interaction between the customer 34 and the service provider 36, as represented in the graphical representation 32, which can be positioned near or adjacent to the scenario description 40. As an alternative, the scenario description 40 can be in the form of audio that is played when the graphical representation 32 is presented. In example illustrated in FIG. 3, the scenario description 40 indicates that the service provider is explaining to a customer how to perform a complex task and that the service provider 36 is not sure that the customer 34 understands the directions that are being given.

The first service scenario screen 30 also includes a judgment question 42 that relates to the graphical representation 32 and the scenario description 40. The first service scenario screen 30 is configured to accept a response to the judgment question 42 from the user 13 of the candidate system 12. The judgment question 42 can be in the form of a query as to how likely the user 13 of the candidate system 12 would be to respond in a manner described by each of a plurality of candidate responses 44.

Each of the candidate responses 44 includes a description of the manner in which the service provider 36 would respond to the scenario. As input, the first service scenario screen 30 is configured to accept a user-generated assessment relating to each of the candidate responses. In the example illustrated in FIG. 3, one of the candidate responses 44 explains that the service provider 36 would slow down and ask if the customer 34 has any questions as the service provider 36 explains the instructions piece by piece.

Associated with each candidate response 44 is an input control 46 that allows the user 13 of the candidate system 12 to input their assessment as to the likelihood that they would respond in the manner specified by the candidate response 44. The user's responses are indicated using the input controls 46, are transmitted to the assessment server 14, and are stored and processed by the testing module 18.

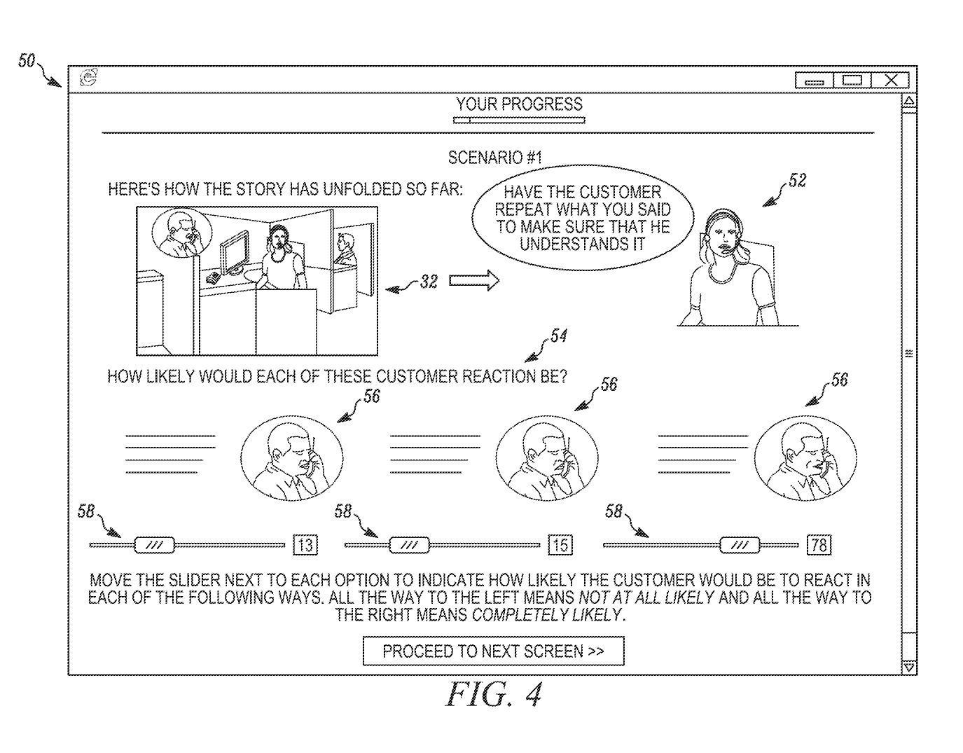

After the user responds to the judgment question 42 of the first service scenario screen 30, a second service scenario screen 50 is displayed, as shown in FIG. 4. The second service scenario screen 50 includes a summary of the scenario and an identified response 52, showing the manner in which the service provider 36 will respond. The identified response 52 can correspond to the response that the user 13 of the candidate system 12 indicated as being their most likely response in the first service scenario screen 30.

The second service scenario screen 50 includes a reaction question 54. The reaction question 54 is made with respect to one or more potential customer reactions 56. The reaction question 54 can ask the user to assess each of the potential customer reactions 56. As an example, the reaction question 54 can ask the user to indicate how likely they believe each potential customer reaction 56 would be using an input control 58. As an example, three potential customer reactions could be presented on the second service scenario screen, in which case, the user 13 is asked to rate the likelihood of each of the potential customer reactions 56. The user responses are indicated using the input controls 58, are transmitted to the assessment server 14, and are stored and processed by the testing module 18.

After completion of the second service scenario screen 50, the user 13 of the candidate system 12 can be presented with a final screen that provides a summary of the scenario, the identified response 52, and the potential customer reaction 56 that the user of the candidate system 12 indicated was most likely to occur.

The assessment test can proceed by presenting additional service judgment scenarios to the user of the candidate system 12. The user's responses regarding each scenario are transmitted to the assessment server 14 and are stored and tracked by the testing module 18. The scenarios can be designed such that these responses are relevant to the personality attributes that were profiled in the context of the ideal service provider evaluation screen 24.

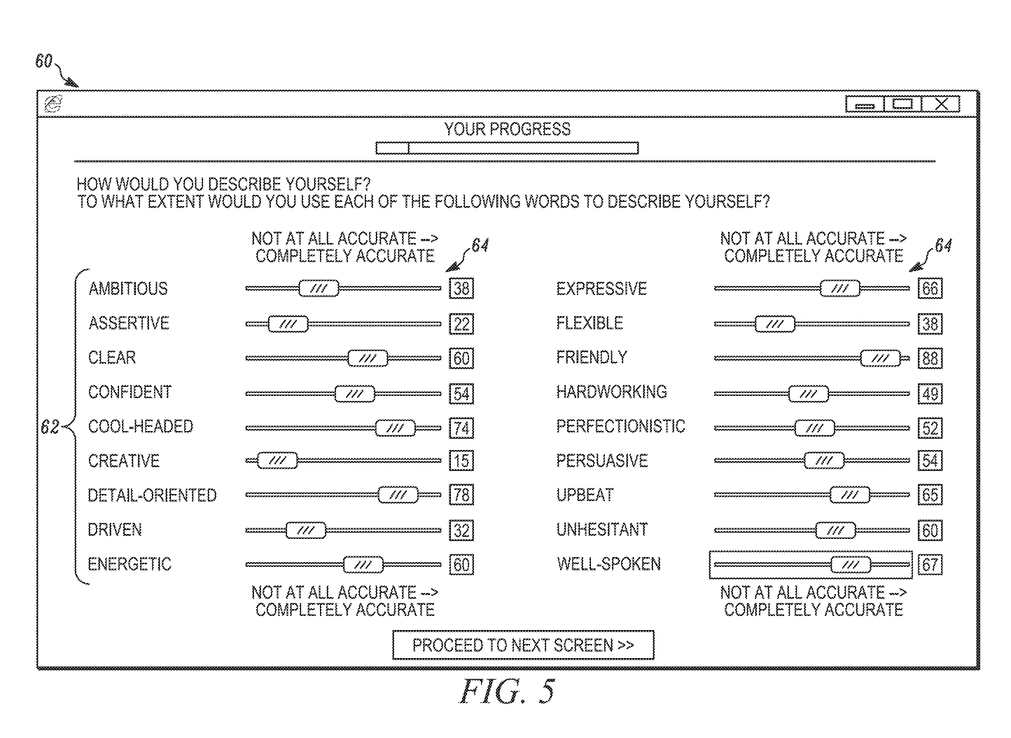

The assessment test includes self assessment of the user's perception of his or her own personality qualities. As shown in FIG. 5, a self evaluation screen 60 is presented to the user 13 of the candidate system 12. The self evaluation screen 60 tasks the user with rating themselves with respect to a plurality of personality qualities 62 that are associated with performance of the job for which the user is applying. An input control 64 is associated with each of the personality qualities 26. Each input control 64 accepts an input from the user of the candidate system 12 that represents an assessment by the user as to the extent to which the user possesses the corresponding personality quality of the personality qualities 62. The user's responses are indicated using the input controls 64, are transmitted to the assessment server 14, and are stored and processed by the testing module 18.

The personality qualities 62 included in the self evaluation screen 60 can be identical to the personality qualities 26 that were previously presented to the user 13 in the ideal service provider evaluation screen 24. This allows the exercise presented by the self evaluation screen 60 to be contrasted against the earlier task of evaluating an ideal service provider, in the exercise presented by the ideal service provider evaluation screen 24. Also, by having the user 13 complete an intervening activity, such as the service judgment scenarios, between presentation of the ideal service provider evaluation screen 24 and the self evaluation screen 60, the likelihood that the user 13 will artificially tailor their responses to the self evaluation screen 60 to match their responses to the ideal service provider evaluation screen 24 is decreased.

Upon conclusion of the assessment test, the inputs that were received by the assessment server 14 are processed to generate as output a score indicative of the user's ability to provide customer service or client service based on the inputs. The score is calculated based on three main components that are derived from the inputs: the user's past experiences, the user's personality, and the user's ability to make and understand service judgments. As an example, a component score relating to past experiences is calculated based on the inputs received from the past experiences input screen. A component score relating to service judgments is calculated based on inputs received during presentation of the service judgment scenarios. A component score relating to personality can be calculated based on the inputs received during presentation of the ideal service provider evaluation screen 24 and the self evaluation screen 60.

The component scores can be calculated in any desired manner, such as by calculating a deviation of each input from a base line response and subtracting the deviation of each input from a maximum possible value to produce the component score. These component scores are used to calculate the score indicative of the user's ability to provide customer service or client service. This calculation can be made in any suitable manner, such as by calculating a weighted average of the component scores. The component scores can be calculated and delivered to the prospective employer system 10 by the reporting module 20 of the assessment server 14.

In another embodiment, the assessment test can be offered to a user by a user-profile server. For example, the user-profile server can store computer-generated user profiles for publication on a social networking website. The user can be notified of the ability to take an assessment test by the social networking website. If the user takes the assessment test, the user can receive a score from the assessment server 14 which can then be published by the user on a credential certificate, for example, as part of the user's computer-generated user profile on the social networking website. The user can also choose not to include the score as part of the user's computer generated user profile.

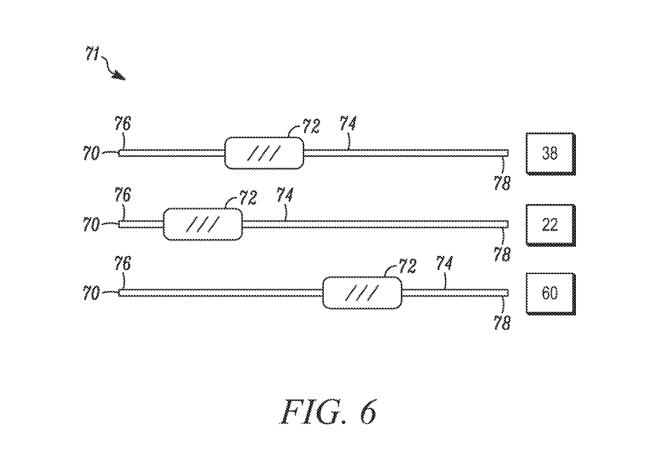

The input controls utilized by various screens of the assessment test can be configured to receive a value that falls within a predetermined range. As an example, the input received from the user is often a value between 0 and 100. This input is entered via standard personal computer input devices and a GUI presented by the candidate system 12. Specifically, a representation of a control device that is movable in response to user-actuated input is used to gather the most of the previously described inputs. For example, the control device is in the form of a slider bar control 70 that is displayed by the candidate system 12 as part of a slider bar control grouping 71, as shown in FIG. 6. As the user 13 moves the mouse or other control associated with the candidate system 12, the position of a slider element 72 moves along a bar 74 between a first extent 76 of the bar 74 and a second extent 78 of the bar 74. By manipulating the slider element 72, the individual can input a response of between a minimum value, such as zero, and a maximum value, such as 100. The minimum value is selected when the slider element 72 is positioned at the first extent 76 of the bar 74 and the maximum value is selected when the slider element is positioned at the second extent 78 of the bar 74. The slider bar control 70 can be configured to prevent identical numbers from being entered with respect to two or more instances of the slider bar control 70 in the grouping 71.

By forcing the individual to move the slider bar control 70 for each answer, the risk of individuals falling into “response rut” or a response set is reduced. Response rut occurs when an individual responds to a series of multiple-choice or rating response question with the same answers or very similar answers. For example, an individual might enter “3” repeatedly for every item in a five-item scale. The use of the slider bar control with a rating range of 0-100 encourages individuals to be more precise, deliberate, and intentional with their response behaviors, allowing for greater sensitivity in the ratings and increasing the chance that final scores based on data from these sources will be more easily distinguishable across multiple individuals. The intuitive nature of the slider bar control 70 also makes responding easier for the user 13, as it is clear that closer to zero represents less likely or a lower rating and closer to 100 represents a more likely or a higher rating. This is a clearer approach to assessment than asking individuals to distinguish between arbitrary rating anchors such as “Somewhat likely” and “Moderately likely” or “Slightly likely”.

Where a grouping of the slider bar controls are presented, such as in the ideal service provider evaluation screen 24, the slider bar controls 70 in the grouping can be configured to prevent two of the slider bar controls in the grouping from being set to the same value. This further prevents the inputs that are submitted by the user 13 from exhibiting a “response rut” pattern.

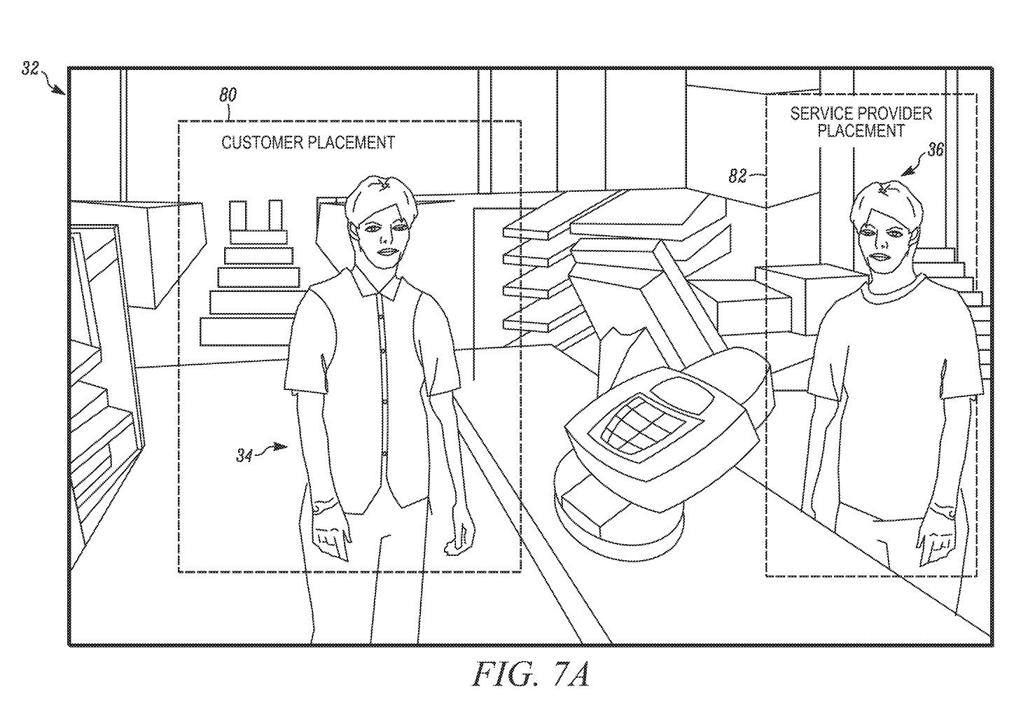

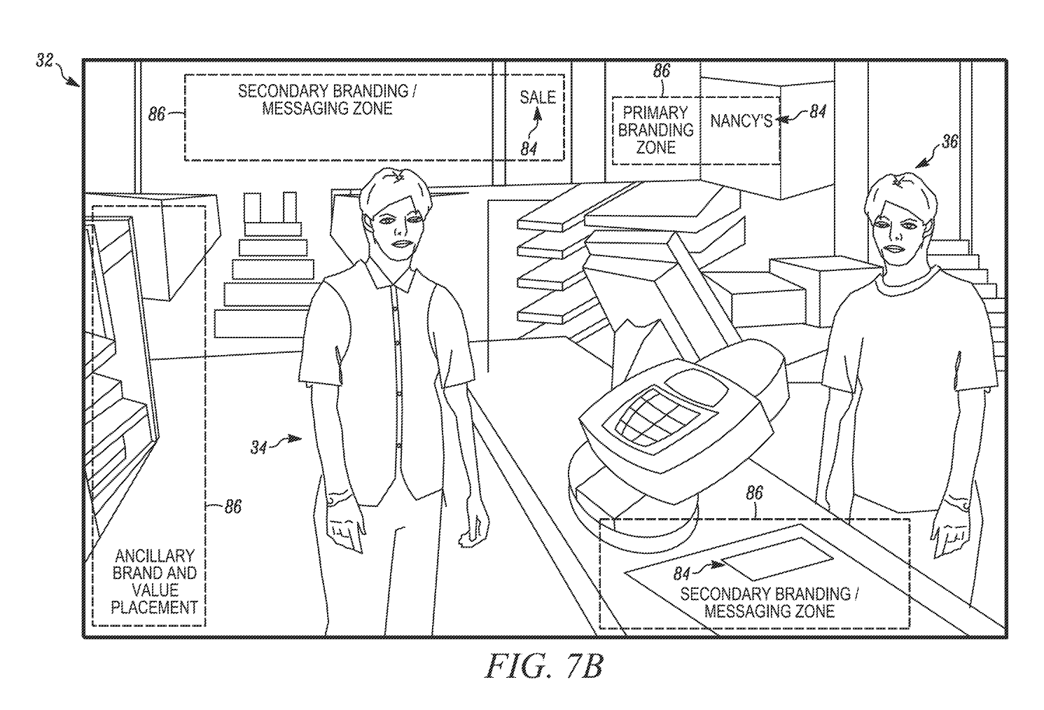

The graphical representation 32 that is presented during each service judgment scenario will now be described in more detail in FIGS. 7A and 7B. Each graphical representation 32 depicts a work scenario that occurs at least in part on the premises of the prospective employer 11. The graphical representation 32 includes hand-drawn images of graphics depicting the service provider 36 and the customer 34 in the environment 38, which is representative, at least in part, of a facility used by the prospective employer 11, such as the employer's place of business. The hand drawn images are two dimensional images that rendered by a person using drawing tools that allow control over the final representation of the image. The hand drawn images are stored in a computer readable format, such as GIF, JPEG or other suitable formats. As one example, the hand-drawn images can be drawn by an artist using a digital pen tablet and either raster or vector based painting or illustration computer software. As another example the hand drawn images could comprise or be based upon images drawn on paper or other suitable media and then digitized using conventional means such as a scanner. Computer rendered images based upon mathematical representations of three dimensional geometry are expressly excluded from the scope of hand drawn images.

Each graphical representation 32 can be configured by changing the race, gender, clothing or position of the persons depicted in the scenario. For example, a service provider 36 depicted in the graphical representation 32 can be shown wearing the official uniform of the prospective employer 11. The graphical representations 32 also allow for branding and organizational cues that enhance the role playing capabilities of the assessment test.

The graphical representations 32 can be standardized. As an example, the customer 34 is consistently placed within a predefined customer placement zone 80 and the service provider 36 is consistently placed within a predefined service provider placement zone 82, as shown in FIG. 7A. The customer placement zone 80 and the service provider placement zone 82 are spaced from one another laterally across the image. For example, with the customer placement zone 80 and the service provider placement zone 82 can each be positioned adjacent to a respective side of the graphical representation 32. As a further example of standardization, the customer 34 and the service provider 36 are depicted using consistent sizes, placements and perspectives.

The graphical representations 32 can each depict a visual attribute of the prospective employer 11. The visual attribute of the prospective employer 11 can be one or more of trade dress, brand, facility decor, products or employee uniform. As an example, the environment 38 can depict the facility of the prospective employer 11. As another example, the branding elements 84 can be placed in predefined branding placement zones 86, as shown in FIG. 7B. The visual attribute can also provide cues as to the values, mission, and competency of the prospective employer 11. As an example, if the prospective employer 11 is a research hospital, the environment 38 can be designed to provide visual cues that reinforce perceptions regarding the research competency of the hospital.

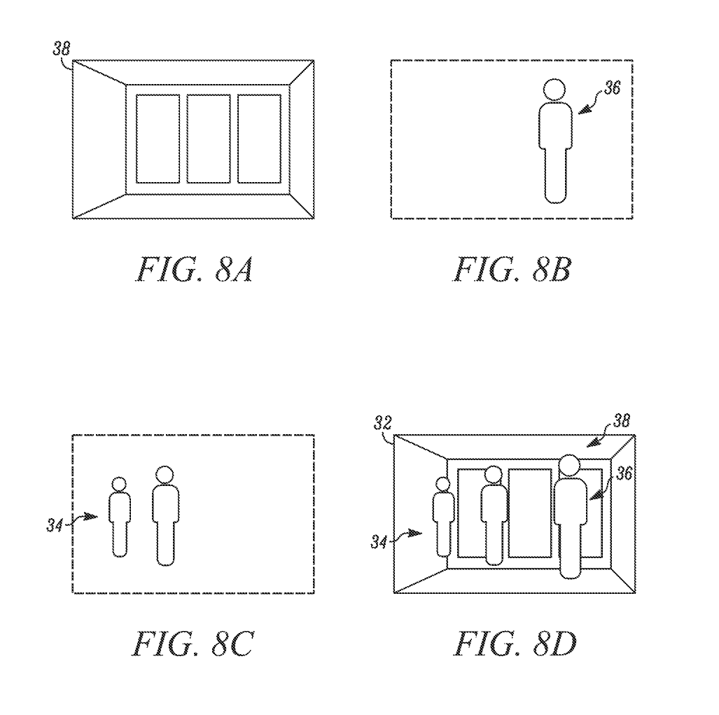

As shown in FIGS. 8A-8D, the graphical representations 32 can be constructed from individual hand-drawn graphics that are assembled into a composite image depicting a work scenario occurring at least in part on the premises of the specified employer. As an example, the environment 38 (FIG. 8A), the service provider 36 (FIG. 8B), and the customer 34 (FIG. 8C) can each be separate graphic elements that are contained in separate image files. The separate image files can be partially transparent images to allow for compositing. Other features, such as the branding elements 84, can be provided as graphic elements that are contained in separate image files. The graphical elements are composited to form the graphical representation (FIG. 8D).

The graphical content of the assessment test can be either or both of configurable and customizable. Configuration and customization can be controlled by the prospective employer 11 using the authoring module 22, thereby allowing the prospective employer 11 to dictate the context of each of the service judgment scenarios. This can include configuring the scenarios by choosing the graphic elements that will be incorporated into the graphical representations 32 from predefined resource libraries that are associated with the assessment server 14. This allows the prospective employer 11 to quickly and conveniently design the graphical representations 32 from predefined graphic elements. Optionally, the service judgment scenarios can include graphic elements that are customized to display visual attributes that are associated with the prospective employer 11. This can include creation of custom graphic elements that represent or are associated with the prospective employer. As one example, the prospective employer 11 can customize the scenarios by creation of customized graphic elements that resemble a facility used by the prospective employer 11.

The authoring module 22 includes an interface that allows the employer 11 to select the graphic elements corresponding to the customer 34, the service provider 36, and the environment 38. This can be in the form of a web page that is generated by the authoring module 22, transmitted to the prospective employer system 10, and displayed by the prospective employer system 10. Available graphic elements are displayed, and can be selected by the employer 11 for use as the graphic elements corresponding to the customer 34, the service provider 36, and the environment 38. The available graphic elements can allow selection of the gender, ethnicity, dress, etc. of the customer 34 and the service provider 36. Similarly, the available graphic elements can allow selection of the environment 38 to be representative of a facility used by the prospective employer 11, such as the premises of or place of business of the prospective employer 11. Other graphic elements can be selected for inclusion in the graphical representation 32. The additional graphic elements can include the branding elements 84, and other logos, props and decorations. Logos, branding, and photo references for the environment 38 can be submitted to the assessment server 14 by the employer 11 to allow for further customization of the graphic elements.

The assessment server 14 then assembles them into a single image that will serve as the graphical representation 32. As an example, the graphic elements can be combined at using a server side at API or software package that is operable to layer the selected graphic elements, and flatten the graphic elements into the single image that will serve as the graphical representation 32. This image is indexed and saved by the authoring module 22 for later use by the assessment module 18 as part of the assessment test.

By way of customization of the graphical representations 32, the assessment test can be deployed across a variety of industries and for multiple job positions across multiple levels within a single organization. In addition, other portions of the assessment test, such as the past experiences input screen, the ideal service provider evaluation screen 24, and the self evaluation screen 60 can be configured so that they are non-industry specific, so that the assessment test can be deployed in any industry without reconfiguration of these sections.

The authoring module 22 can further allow the prospective employer to fine tune the scoring performed by the assessment server 14. For example, the authoring module 22 can be configured to allow the prospective employer to set ideal values for each of the inputs that are to be supplied by the user, or to set minimum and maximum acceptable ranges for the inputs that are to be supplied by the user.

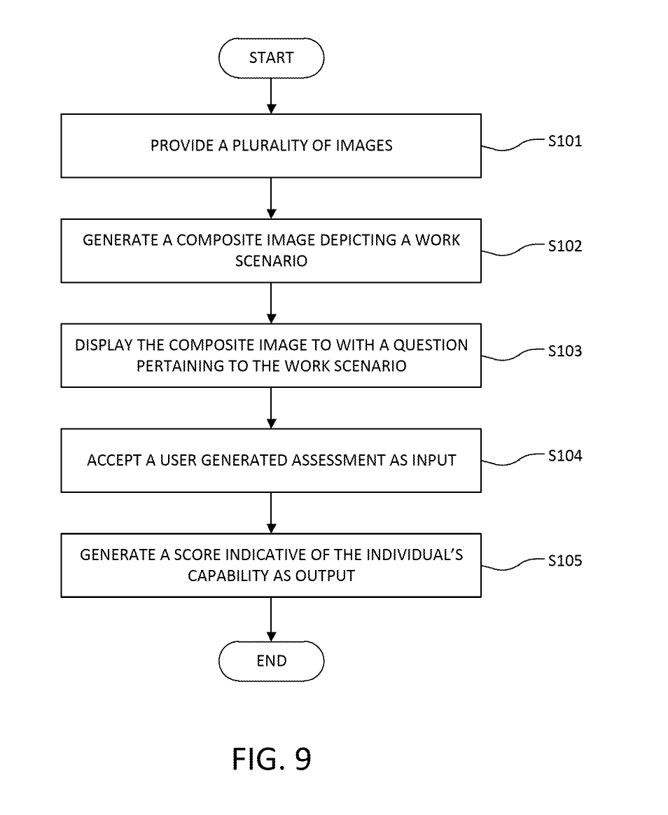

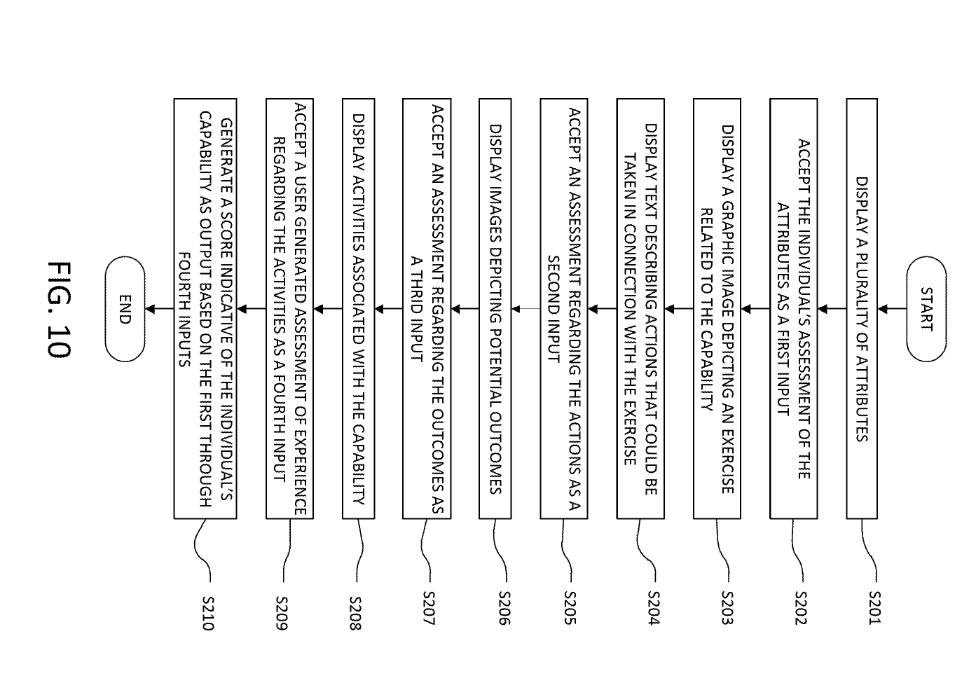

An exemplary method for evaluating at least one capability of an individual seeking or holding a job with a specified employer will now be explained with reference to FIG. 9.

In Step S101, a plurality of images are provided. The images include at least one graphic element depicting the service provider 36, at least one graphic element depicting the customer 34 of the prospective employer 11, and at least one graphic element depicting the environment 38, which at least partially represents a facility used by the prospective employer 11, such as a place of business of the prospective employer 11.

The process proceeds to Step S 102, which includes generating a composite image, such as the graphical representation 32, which includes the plurality of images of Step S101. The composite image depicts a work scenario that occurs at least in part in a facility used by the prospective employer, such as on the premises of the prospective employer 11.

Step S103 includes causing the composite image to be displayed with at least one question pertaining to the work scenario, such as the judgment question 42, and a plurality of candidate responses, such as the candidate responses 44, to the at least one question.

In Step S104, at least one user generated assessment of at least one of the plurality of candidate responses is accepted as input. In Step S105, a score indicative of the individual's capability based on the at least one user-generated assessment is generated as output.

A computer implemented method for testing at least one capability of an individual will now be explained with reference to FIG. 10.

In Step S201, a plurality of attributes previously associated with the capability are displayed on a computer monitor, which is used herein broadly to referred to any type of display that is associated with a fixed or mobile computing device. In Step S102, the individual's assessment of the relative importance of each of the attributes to the capability is accepted as a first input.

In Step S203, a graphic image depicting an exercise related to the capability is displayed on a computer monitor. In Step S204, text describing a plurality of alternative actions that could be taken in connection with the exercise that is displayed on the computer monitor. In Step S205, an assessment by the individual with respect to each of the plurality of alternative actions is accepted as a second input.

In Step S206, a plurality of graphic images are displayed on a computer monitor. The graphic images each depict a potential outcome to at least one of the plurality of alternative actions. In Step S207, an assessment by the individual of the likelihood of occurrence of each potential outcome is accepted as a third input.

In Step S208, a plurality of activities associated with the capability are displayed on the computer monitor. At least some of the activities require for their proper performance at least one or more of the plurality of attributes. In Step S209, a user generated indication of the individuals experience in performing each of the plurality of activities is accepted as a fourth input.

In Step S210, a score indicative of the individual's capability is generated and based on the first, second, third, and fourth inputs and is provided as an output.

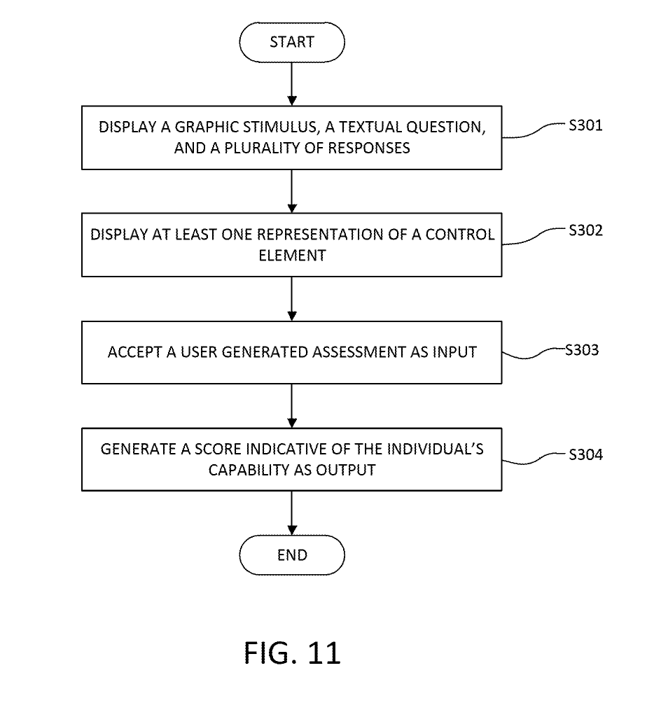

A computer implemented method for evaluating at least one capability of an individual seeking or holding employment will now be explained with reference to FIG. 11.

In Step S301, a graphic stimulus, a textual question pertaining to the graphics stimulus, and a plurality of responses to the textual question are displayed on a monitor. In Step S302, at least one representation of the control element that is movable in response to a user-actuated input device to one or more positions each indicative of a user-generated assessment is displayed on the monitor. In Step S303, at least one user-generated assessment for at least one of the plurality of responses is accepted as input. In Step S304, a score indicative of the individual's capability is generated an output based on the user-generated assessment.

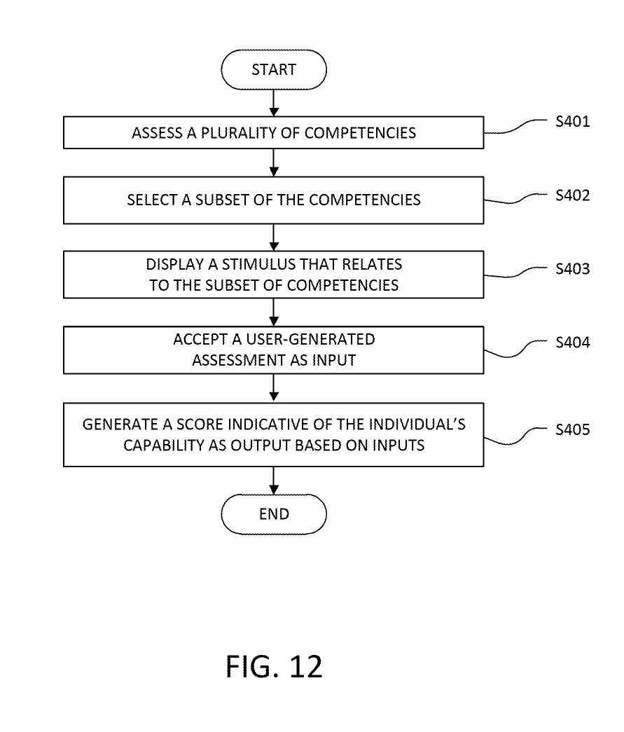

A universal competency assessment method for evaluating at least one capability of an individual seeking or holding a job with a specified employer will now be explained with reference to FIG. 12.

In Step S401, an assessment is made as to a plurality of competencies to determine the degree to which each competency is able to predict whether the individual possesses the capability. This assessment is made without regard to the nature or industry of the job with the specified employer. In Step S402, a subset of the competencies is selected based on ability of each competency to predict whether the individual possesses the capability. The capability can be the ability of the individual to provide service, in which case the competencies are selected so that they are able to predict the extent to which the individual possesses the capability without regard to the particular industry to which the job with the specified employer relates. Thus, the subset of competencies can be utilized as a basis for an assessment test that is universally competent, i.e. able to assess the individual's aptitude with respect to the capability without the need for modifications to the assessment test in order to tailor the assessment test to a particular job or industry.

In the context of an assessment test that is based upon the subset of attributes, in Step S403, a stimulus is displayed to the individual. The stimulus relates to the subset of attributes that were selected in Step S402. The stimulus can be graphical, textual, or a combination of graphical and textual. For example, the stimulus can include one or more evaluation screens are displayed to the individual, such as the past experiences input screen, the ideal service provider evaluation screen, the service judgment scenario screens, and the self evaluation screen. In Step S404, one or more inputs are accepted from the individual. The input is at least one user-generated assessment that is relevant to each competency of the subset of competencies, and is made in response to the stimulus that is displayed in Step S403.

In Step S405, a score indicative of the individual's capability is generated as an output based on based on the at least one user-generated assessment.

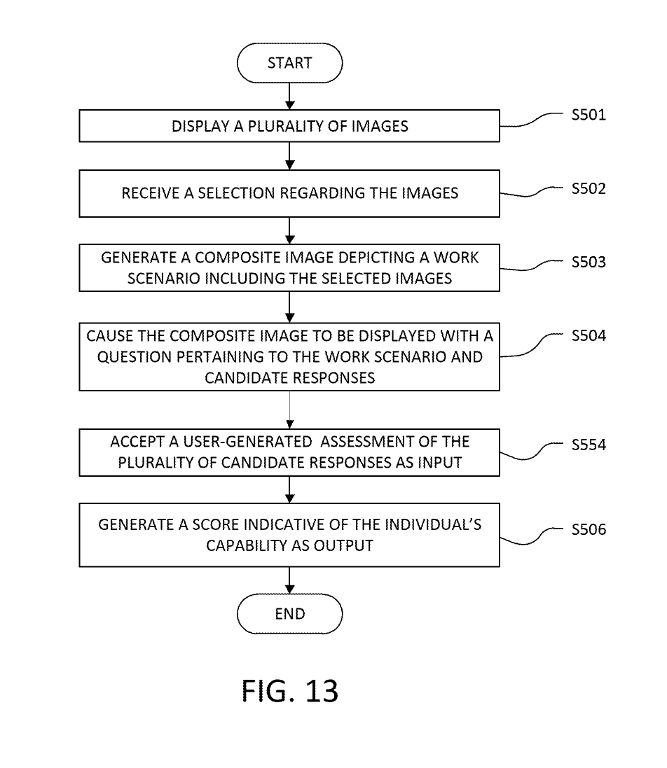

An exemplary method for evaluating at least one capability of an individual seeking or holding a job with a specified employer will now be explained with reference to FIG. 13.

In Step S501, a plurality of images is caused to be displayed. This can be performed by the assessment server 14 sending the images as part of a web page that is transmitted to the prospective employer system 10. The images include a plurality of graphic elements depicting the service provider 36, a plurality of graphic elements depicting the customer 34 of the prospective employer 11, and a plurality of graphic elements depicting the environment 38, which at least partially represents facility used by the prospective employer 11, such as a place of business of the prospective employer 11.

In step S502, a selection is received regarding the plurality of images. The selection identifies at least one graphic element depicting the service provider 36, at least one graphic element depicting the customer 34, and at least one graphic element depicting the environment 38.

The process proceeds to Step S503, which includes generating a composite image, such as the graphical representation 32, which includes the images that were identified in Step S502. The composite image depicts a work scenario that occurs at least in part on the premises of the prospective employer 11.

Step S504 includes causing the composite image to be displayed with at least one question pertaining to the work scenario, such as the judgment question 42, and a plurality of candidate responses, such as the candidate responses 44, to the at least one question.

In Step S505, at least one user generated assessment of at least one of the plurality of candidate responses is accepted as input. In Step S506, a score indicative of the individual's capability based on the at least one user-generated assessment is generated as output.

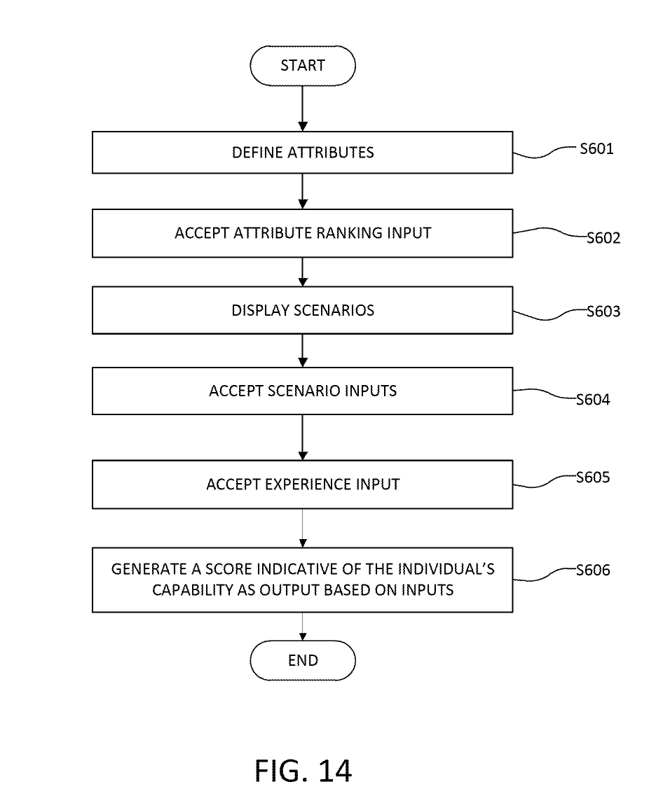

A method for evaluating at least one capability of an individual seeking or holding a job with a specified employer will now be explained with reference to FIG. 14.

In Step S601, a plurality of attributes that are associated with the capability is defined. The attributes can be non-industry specific. In Step S602, an attribute ranking input is accepted, which represents a user generated assessment of the relative importance of each of the plurality of attributes.

In Step S603, each of a plurality of scenarios is displayed. In Step S604, one or more scenario inputs are accepted. The scenario inputs represent user generated responses to the plurality of scenarios, wherein the scenario inputs are relevant to one or more of the attributes.

In Step S605, an experience input is accepted. The experience input represents a user generated indication of the individual's experience in performing each of a plurality of activities. At least some of the activities require for their proper performance at least one or more of the plurality of attributes.

In Step S606, a score indicative of the individual's capability is generated as an output based on the attribute ranking input, the scenario inputs and the experience input.

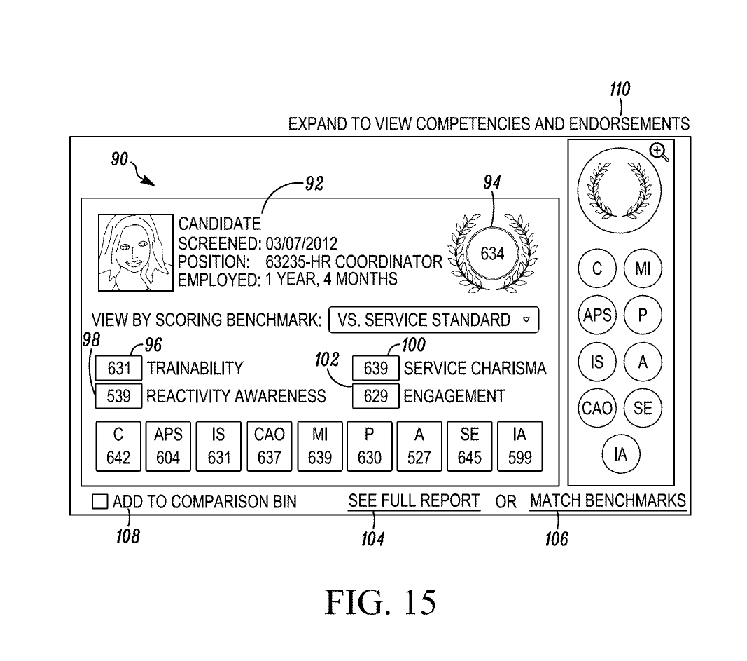

Any of the score-generation embodiments described in FIGS. 9-14 or any other method of score generation can be the source of the score used to generate a user credential as described in connection with FIGS. 15-17.

FIG. 15 is an illustration showing a credential certificate 90 as displayed on a computer-implemented profile of an individual, for example, a user having a computer-generated user profile on a social networking website. The credential certificate 90 includes biographical information 92 related to an individual such as a job candidate's name, date of screening for taking the assessment test, current work position of the job candidate, and length of employment. The credential certificate 90 also includes at least one representation of a score, the score being based on the test inputs provided by the user in response to the assessment test. The test inputs can be indicative of a user-generated assessment given by the individual in response to textual questions posed to the individual during the assessment test as described above in FIG. 11. The representation of the score on the credential certificate 90 can be a medallion 94 including a numerical representation of the individual's overall performance on the assessment test. For example, “Candidate” has achieved an overall score of 634 on the assessment test as displayed in the medallion 94.

The credential certificate 90 can also include graphical representations of one or more competency assessments, each competency assessment predicting whether the individual possesses a specific capability based on the test inputs provided by that individual. Competency assessments can be displayed as compilations of various competencies, for example, a trainability assessment 96, a reactivity-awareness assessment 98, a service-charisma assessment 100, and an engagement assessment 102. Each of the competency assessments can represent a different skill possessed by the individual, the different skills being potentially desirable to employers. The overall score displayed on the credential certificate, for example, the score shown in medallion 94, can be a compilation, average, or pre-defined weighting of the various competency assessments.

The credential certificate 90 can also include one or more interface elements that can be activated to request additional information about the individual and/or the individual's performance on the assessment test. For example, the credential certificate 90 can include a see-full-report element 104. If an authorized employer activates the see-full-report element 104, for example, by using a mouse to select the see-full-report element 104 when viewing the credential certificate 90, the authorized employer can be sent a link to the plurality of test inputs provided by the individual during the assessment test.

As another example interface element, the credential certificate 90 can include a match-benchmarks element 106. If an authorized employer activates the match-benchmarks element 106, the authorized employer can be sent a link to a second score, one differing from the score displayed in the medallion 94 in that the second score is based on the test inputs provided by the individual as applied to a custom scoring model associated with the authorized employer. The custom scoring model can be developed or defined by the authorized employer to highlight competencies important to the employer.

As another example interface element, the credential certificate 90 can include an add-to-comparison-bin element 108. If an authorized employer activates the add-to-comparison-bin element 108, the credential certificate 90 can be saved by the prospective employer system 10, the assessment server 14, or the user-profile server such that the credential certificate 90 for the given individual, “Candidate,” can be compared to other credential certificates or test inputs given by other individuals. For example, an authorized employer could select the add-to-comparison-bin element 108 in order to compare “Candidate's” overall score on the assessment test to overall scores achieved by other prospective employees to assist in making a hiring decision.

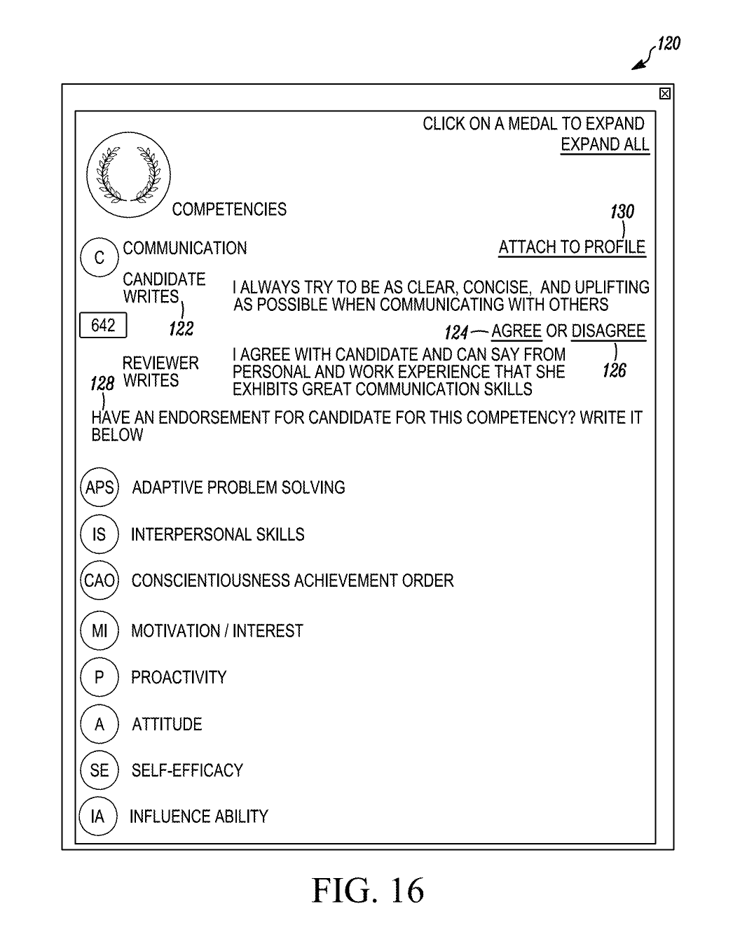

As another example interface element, the credential certificate 90 can include a competencies-and-endorsements element 110. If an authorized employer activates the competencies-and-endorsements element 110, the authorized employer can be sent a link to view a competencies-and-endorsements certificate 120, as further described in FIG. 16.

FIG. 16 is an illustration showing a competencies-and-endorsements certificate 120. The competencies-and-endorsements certificate 120 can include specific scores calculated for a variety of competencies and based on responses given on the assessment test. Competencies can include but are not limited to communication, adaptive problem solving, interpersonal skills, conscientiousness achievement order, motivation/interest, proactivity, attitude, self-efficacy, and influence ability. The individual competencies can also be combined, weighed, or otherwise averaged into the various competency assessments as shown in FIG. 15.

The competencies-and-endorsements certificate 120 can also include interface elements that provide additional information regarding the individual highlighted on the credential certificate 90. One example interface element that can be included in the competencies-and-endorsements certificate 120 is a candidate-response element 122. The candidate-response element 122 can highlight individual responses to specific user-generated assessments on the assessment test.

For example, “Candidate” responds to a question on the assessment test related to a communication competency with the following statement: “I always try to be as clear, concise, and uplifting as possible when communicating with others.” An authorized employer is able to view this statement in connection with the communication competency highlighted on the competencies-and-endorsements certificate 120. The candidate-response element 122 can also include additional interface elements such as an agree element 124 and a disagree element 126. Activating the agree element 124 or disagree element 126 can allow an authorized employer or other party authorized by the individual to either agree or disagree, respectively, with “Candidate's” statement about their own communication competency.

If either the agree element 124 or disagree element 126 are selected, the authorized employer or other party is presented with the opportunity to enter an endorsement, recommendation, or other comment regarding “Candidate” in an endorsement element 128. An example endorsement for “Candidate” is shown as given by “Reviewer” in the communication competency section of the competencies-and-endorsements certificate 120: “I agree with ‘Candidate’ and can say from personal experience that she exhibits great communication skills ” Each of the competencies included in the competencies-and-endorsements certificate 120 can include the candidate-response element 122, the endorsement element 128, the agree element 124, and the disagree element 126.

The candidate-response element 122 can also include an interface element allowing publication of a response to a computer-generated user profile. The attach-to-profile element 130 can allow an individual to link their response to a given assessment test question to their computer-generated user profile. For example, when the individual activates the attach-to-profile element 130 shown as part of the candidate-response element 122, the statement “I always try to be as clear, concise, and uplifting as possible when communicating with others” will be linked to the individual's computer-generated user profile.

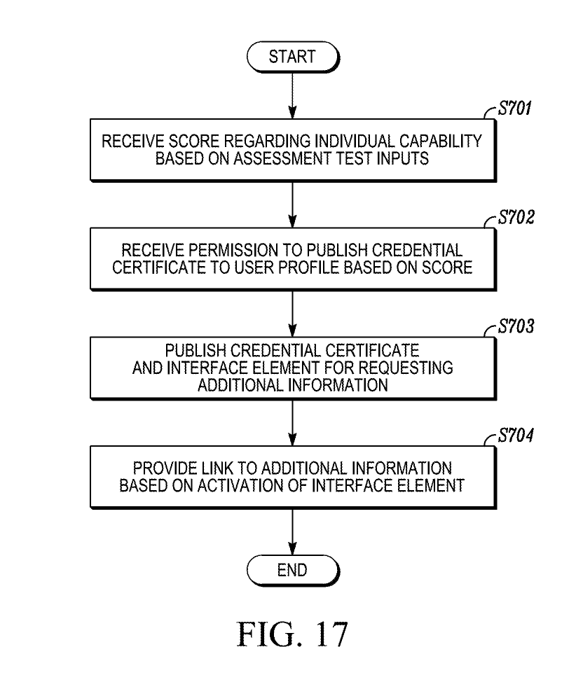

FIG. 17 is a flow chart showing a method for publishing a user credential.

In step S701, a score is received regarding at least one capability of an individual. The score can be based on a plurality of test inputs provided by the individual in response to an assessment test. For example, the score can be a numerical representation of the individual's overall performance on the assessment test as shown in the medallion 94 on the credential certificate 90 in FIG. 15 which displays the score “634.”

The plurality of test inputs can be indicative of user-generated assessments given by the individual in response to textual questions posed to the individual during the assessment test. For example, the individual can be presented a test question requesting a comment on the individual's ability to communicate. The individual can respond by inputting, “I always try to be as clear, concise, and uplifting as possible when communicating with others” as shown on the competencies-and-endorsements certificate 120 in FIG. 16. The communication competency can include a score, for example the score “642” as shown in FIG. 16, based at least partially on the response given by the individual when asked to comment on the ability to communicate.

The score can also be based on a plurality of competency assessments, with each competency assessment predicting whether the individual possesses a specific capability based on the plurality of test inputs. The competency assessments can include, for example, the trainability assessment 96, the reactivity-awareness assessment 98, the service-charisma assessment 100, and the engagement assessment 102 as shown on the credential certificate 90 of FIG. 15. The competency assessments can each be based on a subset of the individual competencies shown in FIG. 16. Each individual competency, such as the adaptive problem solving competency and interpersonal skills competency, can be based on responses given by the individual to questions posed to the individual on those subjects during the assessment test.

In step S702, permission can be received, from the individual, to allow publication of a credential certificate on a computer-implemented user profile associated with the individual. For example, after taking the assessment test, the individual can be sent the results of the assessment test and an electronic link for publishing the results of the assessment test on their computer-implemented user profile in order to share the results with other individuals and potential employers. By activating the link, the individual can send a signal to the user-profile server that the individual approves publication of the results in the form of a credential certificate, for example, credential certificate 90 shown in FIG. 15.

The credential certificate is based at least in part on the score the individual received for the assessment test and includes at least one interface element for requesting additional information related to the individual or their performance on the assessment test. The interface elements can be directly associated with the credential certificate. For example, the credential certificate 90 can include the see-full-report element 104, the match-benchmarks element 106, the add-to-comparison-bin element 108, and the competencies-and-endorsements element 110 all described above in reference to FIG. 15.

Upon completion of the assessment test, the individual can also be sent a link to a training offer based at least in part on the score received on the assessment test. The link to the training offer can be related to one of the plurality of competency assessments, for example, the trainability assessment 96, the reactivity-awareness assessment 98, the service-charisma assessment 100, or the engagement assessment 102 as described above in FIG. 15. The training offer can include a link to a class for the individual to take or to an article for the individual to review in order to improve their skill in a certain tested area. The link to the training offer can also offer the individual the opportunity to retake the assessment test upon completion of the training being offered.

In step S703, the credential certificate and at least one interface element can be published on the computer-implemented user profile associated with the individual. For example, the credential certificate 90 including various interface elements as shown in FIG. 15 can be highlighted by being displayed near the top of a the individual's web-based computer-generated user profile in order to be visible to other parties such as potential employers during a search for individuals having a defined set of credentials or keywords associated with their computer-generated user profiles.

In step S704, a link to additional information regarding the individual can be provided to an authorized employer in response to a request for the additional information from the authorized employer. For example, when the individual gives permission to publish the credential certificate 90 as shown in FIG. 15, the individual can also be given the opportunity to specify whether third parties, such as employers, can be authorized to request additional information related to the individual and/or assessment test. Any party given permission to access additional information can be included in the description “authorized employers,” though it is understood that the party need not actually be an employer, i.e., any third party can be given authorization to access additional information regarding the assessment test.

The request for the additional information is based on activation of at least one interface element by the authorized employer. For example, any one of the see-full-report element 104, the match-benchmarks element 106, the add-to-comparison-bin element 108, or the competencies-and-endorsements element 110 described in reference to FIG. 15 can be activated by an authorized employer. Upon activation of the element, the user-profile server can send a link to the authorized employer that will allow the authorized employer to access the additional information requested.

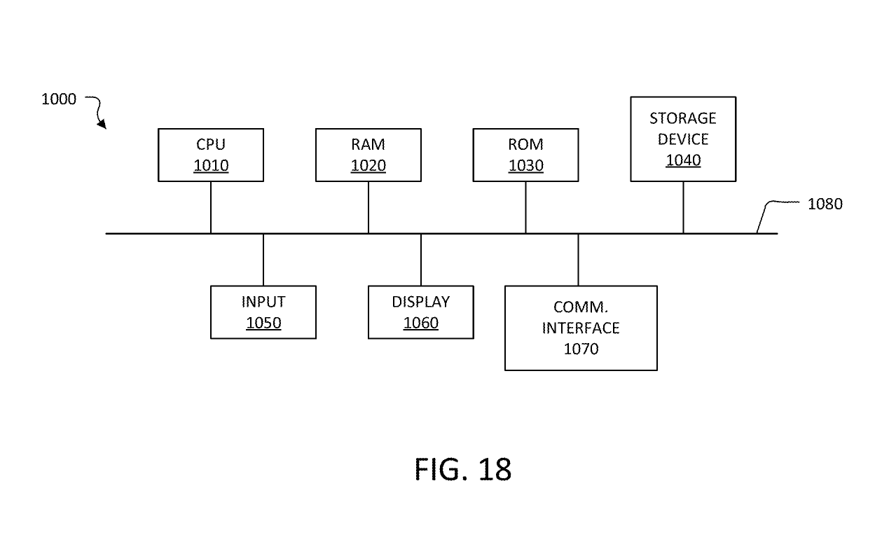

Each of the prospective employer system 10, the candidate system 12, the user-profile server, and the assessment server 14 can be implemented in the form of software suitable for performing the processes detailed herein that is executed by a separate conventional computer 1000, as shown in FIG. 18. The computer 1000 can be any suitable conventional computer. As an example, the computer 1000 includes a processor such as a central processing unit (CPU) 1010 and memory such as RAM 1020 and ROM 1030. A storage device 1040 can be provided in the form of any suitable computer readable medium, such as a hard disk drive. One or more input devices 1050, such as a keyboard and mouse, a touch screen interface, etc., allow user input to be provided to the CPU 1010. A display 1060, such as a liquid crystal display (LCD) or a cathode-ray tube (CRT), allows output to be presented to the user. A communications interface 1070 is any manner of wired or wireless means of communication that is operable to send and receive data or other signals using the network 16. The CPU 1010, the RAM 1020, the ROM 1030, the storage device 1040, the input devices 1050, the display 1060 and the communications interface 1070 are all connected to one another by a bus 1080.

As previously noted, the network 16 allows communication between the prospective employer system 10, the candidate system 12, the user-profile server, and the assessment server 14. The network 16 can be, for example, be the internet, which is a packet-switched network, a local area network (LAN), wide area network (WAN), virtual private network (VPN), a wireless data communications system of any type, or any other means of transferring data. The network 16 can be a single network, or can be multiple networks that are connected to one another. It is specifically contemplated that the network 16 can include multiple networks of varying types. For example, the candidate system 12 can be connected to the assessment server 14 or the user-profile server by the internet in combination with local area networks on either or both of the client-side or the server-side.

While a single candidate system 12 has been described, it should be understood that multiple clients can simultaneously connect to the assessment server 14 and user-profile server. Furthermore, while a single assessment server 14 and user-profile server have been described, it should be understood that the functions of the assessment server 14 and/or user-profile server can be distributed among a plurality of conventional computers, such as the computer 1000, each of which are capable of performing some or all of the functions of the assessment server 14 and/or user-profile server.

The description herein has been made with reference to an exemplary system in which the assessment test is generated by the assessment server 14 and is transmitted to and administered by the candidate system 12. The assessment test can also be generated and administered by the user-profile server or systems other than a client-server system. As an example, the assessment software or portions of the assessment software, such as the testing module 18, could be resident on the computer utilized to administer the assessment test. In such a system, the results of the test could be compiled and reviewed on the same computer. Alternatively, the user inputs and/or the results of the assessment test could be transmitted to another computer for review and/or processing.

The description herein has been made with reference to assessment of a user's capability to provide customer service or client service. It should be understood, however, that the systems and methods described herein can also be applied to assessment and publication of other capabilities and credentials.

While the disclosure is directed to what is presently considered to be the most practical embodiments, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

1. A computer-implemented method for publishing a user credential, comprising:
receiving a score regarding at least one capability of an individual, wherein the score is based at least on a plurality of test inputs provided by the individual in response to an assessment test;
receiving permission, from the individual, to allow publication of a credential certificate on a computer-implemented user profile associated with the individual, wherein the credential certificate is based at least in part on the score and includes at least one interface element for requesting additional information related to the individual;
publishing the credential certificate and at least one interface element on the computer-implemented user profile associated with the individual; and
providing, to an authorized employer, a link to the additional information in response to a request for the additional information from the authorized employer, wherein the request is based on activation of at least one interface element by the authorized employer.

2. The method of claim 1, wherein the score is a first score, wherein the link to additional information includes a link to a second score, and wherein the second score is based at least on the plurality of test inputs and a custom scoring model associated with the authorized employer.

3. The method of claim 2, wherein the custom scoring model is defined by the authorized employer.

4. The method of claim 1, wherein the link to additional information provided to the authorized employer includes a link to the plurality of test inputs.

5. The method of claim 1, wherein the link to additional information provided to the authorized employer includes a link to recommendations regarding the individual and wherein the recommendations are generated by third parties.

6. The method of claim 1, wherein the link to additional information provided to the authorized employer includes a link to individual responses to specific user-generated assessments.

7. The method of claim 1, wherein each of the plurality of test inputs are indicative of a user-generated assessment given by the individual in response to textual questions posed to the individual during the assessment test.

8. The method of claim 1, further comprising:
transmitting, to the individual, a link to a training offer based at least in part on the score regarding the at least one capability of the individual.

9. The method of claim 1, wherein the score is based on a plurality of competency assessments and each competency assessment predicts whether the individual possesses a specific capability based on the plurality of test inputs.

10. The method of claim 9, further comprising:
transmitting, to the individual, a link to a training offer, wherein the training offer is related to one of the plurality of competency assessments.

11. A non-transitory computer readable medium including program instructions executable by one or more processors that, when executed, cause the one or more processors to perform operations, the operations comprising:
receiving a score regarding at least one capability of an individual, wherein the score is based at least on a plurality of test inputs provided by the individual in response to an assessment test;
receiving permission, from the individual, to allow publication of a credential certificate on a computer-implemented user profile associated with the individual, wherein the credential certificate is based at least in part on the score and includes at least one interface element for requesting additional information related to the individual;
publishing the credential certificate and at least one interface element on the computer-implemented user profile associated with the individual; and
providing, to an authorized employer, a link to the additional information in response to a request for the additional information from the authorized employer, wherein the request is based on activation of at least one interface element by the authorized employer.

12. The non-transitory computer readable medium of claim 11, wherein the score is a first score, wherein the link to additional information includes a link to a second score, and wherein the second score is based at least on the plurality of test inputs and a custom scoring model associated with the authorized employer.

13. The non-transitory computer readable medium of claim 12, wherein the custom scoring model is defined by the authorized employer.

14. The non-transitory computer readable medium of claim 11, wherein the link to additional information provided to the authorized employer includes a link to the plurality of test inputs.

15. The non-transitory computer readable medium of claim 11, wherein the link to additional information provided to the authorized employer includes a link to recommendations regarding the individual and wherein the recommendations are generated by third parties.

16. The non-transitory computer readable medium of claim 11, wherein the link to additional information provided to the authorized employer includes a link to individual responses to specific user-generated assessments.

17. The non-transitory computer readable medium of claim 11, wherein each of the plurality of test inputs are indicative of a user-generated assessment given by the individual in response to textual questions posed to the individual during the assessment test.

18. The non-transitory computer readable medium of claim 11, further comprising:
transmitting, to the individual, a link to a training offer based at least in part on the score regarding the at least one capability of the individual.

19. The non-transitory computer readable medium of claim 11, wherein the score is based on a plurality of competency assessments and each competency assessment predicts whether the individual possesses a specific capability based on the plurality of test inputs.

20. The non-transitory computer readable medium of claim 19, further comprising:
transmitting, to the individual, a link to a training offer, wherein the training offer is related to one of the plurality of competency assessments.
